(19) United States
(12) Patent Application Publication
(10) Pub. No.: US 2015/0214512 A1
(43) Pub. Date: Jul. 30, 2015

(54) BATTERY CELL

(71) Applicant: Samsung SDI Co., Ltd., Yongin-si (KR)

(72) Inventor: Ho-Seong KIM, Yongin-si (KR)

(21) Appl. No.: 14/589,386

(22) Filed: Jan. 5, 2015

(30) Foreign Application Priority Data
Jan. 28, 2014 (KR) 10-2014-0010163

(51) Int. Cl. H01M 2/02

(52) U.S. Cl. CPC H01M 2/0202; H01M 2/0275; H01M 2220/30

(57) ABSTRACT

There is provided a battery cell. The battery cell includes an electrode assembly having an electrode tab, and a pouch configured to accommodate the electrode assembly therein. A protrusion is provided on at least one surface of the pouch in such a way as to protrude towards the electrode assembly. This protrusion restricts the movement of the electrode assembly, thus reducing a defective rate and improving safety.

### RELATED APPLICATIONS

This application claims priority to and the benefit of Korean Patent Application No. 10-2014-0010163, filed on Jan. 28, 2014, in the Korean Intellectual Property Office, the entire contents of which are incorporated herein by reference in their entirety.

### BACKGROUND

1. Field

The present invention relates to a battery cell.

2. Description of the Related Technology

Recently, battery cells have been variously used as power sources of portable electronic devices. As the portable electronic devices are used in various fields, demands on battery cells are rapidly increased. The battery cells may be charged/discharged several times, and thus are economically and environmentally efficient. Therefore, the use of the battery cells is encouraged.

As the miniaturization and lightness of the electronic devices are required, the miniaturization and lightness of the battery cells are also required. However, since the battery cell contains a highly reactive substance such as lithium, this imposes limitations on the miniaturization and lightness due to safety. Further, various types of research into a reduction in defective rate during the manufacture of the battery cells are being conducted.

### SUMMARY OF CERTAIN INVENTIVE ASPECTS

Accordingly, an aspect of the present invention is to provide a battery cell, which achieves a reduction in defective rate as well as an improvement on safety.

According to an embodiment of the present invention, there is provided a battery cell, including an electrode assembly having an electrode tab, and a pouch configured to accommodate the electrode assembly therein, wherein a protrusion is provided on at least one surface of the pouch in that protrudes towards the electrode assembly.

The pouch may include a sealing portion formed along an outer portion thereof, and the protrusion may be provided on at least one surface of the pouch having the sealing portion.

Further, the electrode tab may protrude out through the sealing portion.

The protrusion may be provided on a first surface through which the electrode tab protrudes out of the pouch.

A separator of the electrode assembly may be exposed towards the first surface.

The at least one surface of the pouch having the protrusion may be inclined.

Further, an end of the protrusion may be inclined to be parallel to the at least one surface of the pouch having the protrusion.

An end of the protrusion may form an angle with the at least one surface of the pouch having the protrusion.

The end of the protrusion may be parallel to an end of the electrode assembly.

The protrusion may be provided on a second surface adjacent to the first surface through which the electrode tab protrudes out of the pouch.

The pouch may include a first case configured to define a receiving portion receiving the electrode assembly therein, and a second case configured to cover the first case, and a sectional area of the receiving portion may be reduced in a direction away from a position where the first case meets the second case.

The protrusion may protrude from the at least one surface of the pouch to 0.3 to 0.5 mm.

Further, the protrusion may comprise a plurality of protrusions.

The protrusion may be integrally formed on the pouch.

Other and further objects of the present invention will become apparent from the following description with reference to the accompanying drawings.

The terms or words used in the description and the claims of the present invention should not be interpreted as being limited merely to common and dictionary meanings. On the contrary, they should be interpreted based on the meanings and concepts in keeping with the scope of the invention on the basis of the principle that the inventor(s) can appropriately define the terms in order to describe the invention in the best way.

As is apparent from the above description, the battery cell of the present invention is advantageous in that it is provided with the protrusion so as to prevent the electrode assembly from moving and approaching the sealing portion, thus reducing the defective ratio of the battery cell and improving the safety.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view showing a battery cell according to an embodiment of the present invention;

FIG. 2 is an exploded perspective view showing the battery cell of FIG. 1;

FIG. 3 is a sectional view of the battery cell taken along line A-A′ of FIG. 1;

FIG. 4 is a sectional view of the battery cell taken along line B-B′ of FIG. 1; and

FIGS. 5 and 6 are sectional views showing a battery cell according to another embodiment of the present invention.

### DETAILED DESCRIPTION OF CERTAIN INVENTIVE EMBODIMENTS

The invention will be described more fully hereinafter with reference to the accompanying drawings, in which example embodiments of the inventions are shown. It should be noted that like reference numerals are used to identify like elements throughout different drawings. Although the terms “first”, “second”, etc. are used herein to describe various elements, these elements should not be limited by these terms. These terms are only used to distinguish one element from another element. In the following description, if it is decided that the detailed description of known function or configuration related to the invention makes the subject matter of the invention unclear, the detailed description is omitted.

Hereinafter, the embodiment of the present invention will be described in detail with reference to the accompanying drawings.

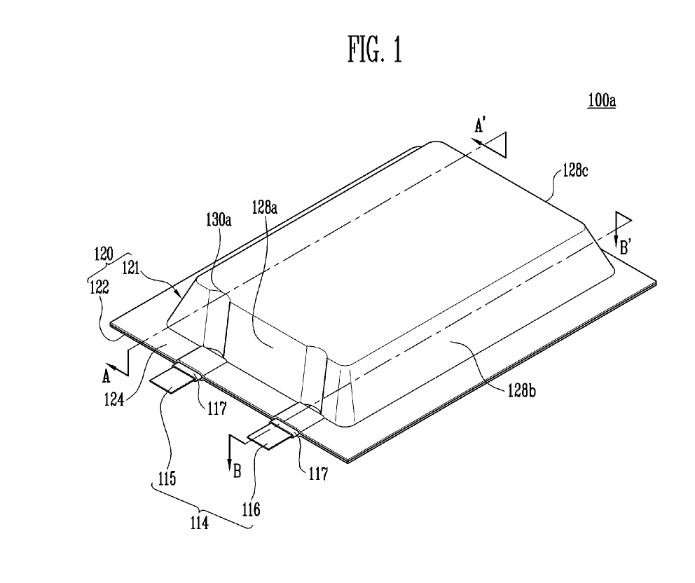

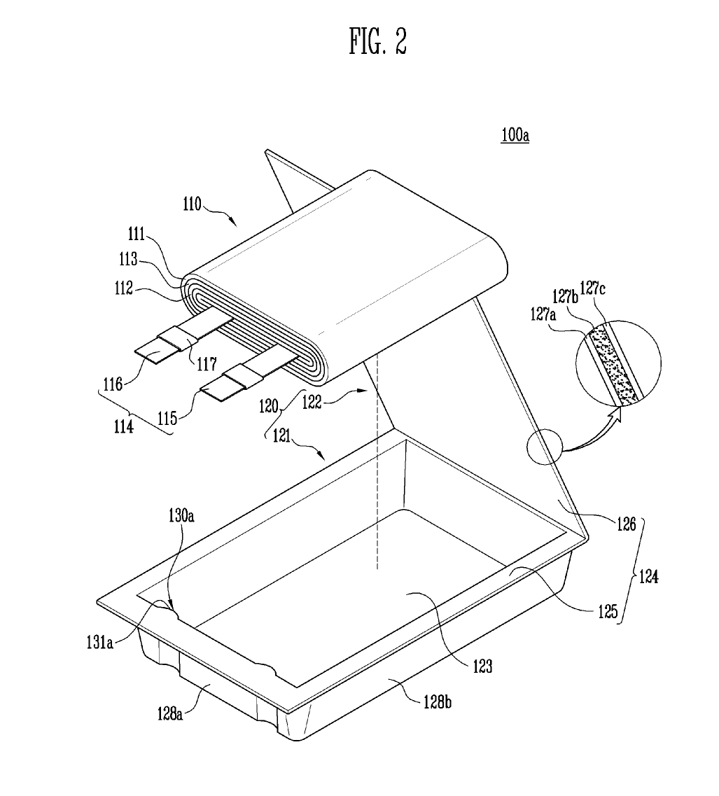

FIG. 1 is a perspective view showing a battery cell 100a according to an embodiment of the present invention, and FIG. 2 is an exploded perspective view showing the battery cell 100a of FIG. 1. For the convenience of illustration and description, FIG. 2 shows the battery cell 100a that is turned upside down from a state of FIG. 1. The battery cell 100a according to this embodiment will be described below with reference to FIGS. 1 and 2.

As shown in FIGS. 1 and 2, the battery cell 100a according to this embodiment includes an electrode assembly 110, and a pouch 120 configured to accommodate the electrode assembly 110 therein. A protrusion 130a may be provided on a first surface 128a of the pouch 120 in such a way as to protrude towards the electrode assembly 110.

The electrode assembly 110 is a member that has on an end thereof an electrode tab 114. The electrode assembly 110 forms the battery cell 100a or a bare cell together with the pouch 120, thus generating electrochemical energy by the transfer of ions or electrons.

In this regard, the electrode assembly 110 may include a first electrode plate 111, a second electrode plate 112, a separator 113 interposed between the first and second electrode plates 111 and 112, and the electrode tab 114 having first and second electrode tabs 115 and 116 which protrude outwards from the electrode assembly 110. The first electrode plate 111 and the second electrode plate 112 may comprise an anode plate and a cathode plate, respectively, while the first electrode tab 115 and a second electrode tab 116 may comprise an anode tab and a cathode tab, respectively. Further, the electrode tab 114 protrudes from an end of the electrode assembly 110 to transmit electrochemical energy produced in the battery cell 100a to the outside. The electrode assembly 110 may be manufactured by various methods, for example, by winding or stacking the first electrode plate 111, the second electrode plate 112 and the separator 113 together. Of course, the present invention may include all types of electrode assemblies 110, such as a stack- or winding-type electrode assembly 110.

The pouch 120 is a member that accommodates the electrode assembly 110 therein, and may include a first case 121 and a second case 122.

By way of example, the first case 121 may have a receiving portion 123 to receive the electrode assembly 110, and the second case 122 may cover the first case 121. Thus, the receiving portion 123 of the first case 121 may be formed to correspond to the shape and size of the electrode assembly 110. For example, it is possible to form the receiving portion 123 through a deep drawing process of producing a seamless hollow container from a flat pate.

Meanwhile, the first case 121 and the second case 122 may be coupled to each other by a sealing portion 124 that is formed along an outer portion of the pouch 120. To be more specific, for example, after the electrode assembly 110 and the electrolyte are put into the receiving portion 123 of the first case 121, the first case 121 comes into close contact with the second case 122. In this state, a first outer portion 125 of the first case 121 and a second outer portion 126 of the second case 122 are thermally fused together to form the sealing portion 124. That is, according to this embodiment, the battery cell 100a may be implemented in a pouch- or polymer-type, for example. Here, the electrode tab 114 of the electrode assembly 110 may be exposed to the outside via the sealing portion 124. According to this embodiment, the receiving portion 123 is formed in the first case 121, and the second case 122 covers the first case 121. However, receiving portions may be formed in both the first case 121 and the second case 122 so that each case receives about half of the electrode assembly 110.

As shown in FIG. 2, the pouch 120 may sequentially include an inner resin layer 127a, a metal layer 127b, and an outer resin layer 127c. The inner resin layer 127a is part that directly faces the electrode assembly 110, and the outer resin layer 127c is part that corresponds to an outermost surface of the pouch 120. The inner resin layer 127a and the outer resin layer 127c may be made of polymer resin that is an electric non-conductor, so as to prevent or inhibit a short circuit. Particularly, since some of the inner resin layer 127a forms the sealing portion 124 and thereby couples the first and second cases 121 and 122 with each other, the inner resin layer 127a may contain cast polypropylene (CPP), for example. Further, the metal layer 127b is provided between the inner resin layer 127a and the outer resin layer 127c to give a predetermined level of mechanical strength to the pouch 120, and may include e.g. aluminum.

The electrode tab 114 of the electrode assembly 110 may be exposed to the outside of the battery cell 100a via the sealing portion 124, and the electrode tab 114 may come into contact with the metal layer 127b exposed at an end of the sealing portion 124, thus causing an electric short circuit.

In order to prevent such a problem, the electrode tab 114 according to the embodiment of the present invention may be further provided with an electrode tab film 117 as an example of a resin portion. Here, the electrode tab film 117 may be provided to be seated on the sealing portion 124, and may comprise an electric non-conductor, thus preventing the short circuit from occurring in the electrode tab 114 and the metal layer 127b. Further, the electrode tab film 117 is made of a substance similar to that of the sealing portion 124, thus allowing the sealing portion 124 to be completely thermally fused. Thereby, the electrode tab 114 made of metal can perfectly come into close contact with the sealing portion 124. Consequently, a sealing force of the pouch 120 can be increased by the electrode tab film 117.

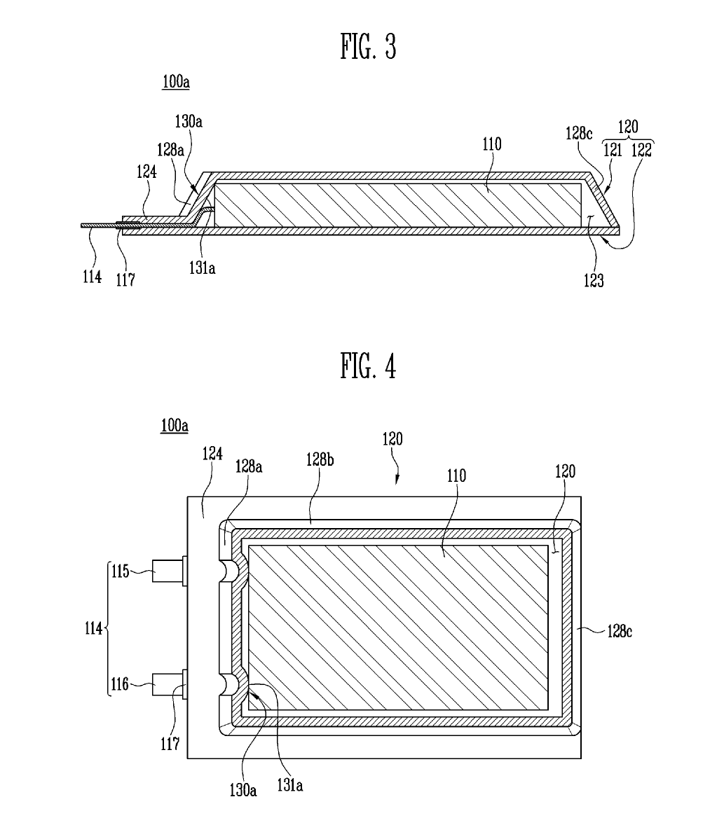

FIG. 3 is a sectional view of the battery cell 100a taken along line A-A′ of FIG. 1, and FIG. 4 is a sectional view of the battery cell 100a taken along line B-B′ of FIG. 1. According to this embodiment, the surfaces of the pouch 120 are referred to as a first surface 128a, a second surface 128b and a third surface 128c. Here, each of the first surface 128a, the second surface 128b, and the third surface 128c merely mean the region itself of the pouch 120 without being divided into an outer surface and an inner surface. Hereinafter, the protrusion 130a of the battery cell 100a according to this embodiment will be described in detail with reference to the drawings.

The receiving portion 123 of the pouch 120 may be formed through a deep drawing process as described above. Here, a gap is present between a line formed by a forming punch and a line formed by a forming die. Thus, in order to insert the electrode assembly 110 into the receiving portion 123, the receiving portion 123 may be relatively larger in size than the electrode assembly 110. Such a shape is advantageous in terms of the injection of the electrolyte, but is disadvantageous in that the electrode assembly 110 may be undesirably moved when the electrode assembly 110 is put into the receiving portion 123. Further, when the first outer portion 125 of the first case 121 is thermally fused to the second outer portion 126 of the second case 122 to form the sealing portion 124, heat is applied. In this regard, if the electrode assembly 110 moves and approaches the sealing portion 124, the separator 113 may be fused by sealing heat and pressure. The fusion of the electrode assembly 110 makes it difficult to perform a degassing process of removing gas during the assembly of the battery cell 100a, thus leading to defective formation.

In order to solve the problems, as shown in FIGS. 3 and 4, according to the present invention, the protrusion 130a may be provided on the pouch 120. The protrusion 130a may protrude from at least one surface of the pouch 120 towards the electrode assembly 110, thus preventing the electrode assembly 110 from approaching the sealing portion 124 and thereby preventing or inhibiting the electrode assembly 110 from being fused by heat. To be more specific, the pouch 120 may have a hexahedron-like shape except the sealing portion 124. The protrusion 130a may protrude inwards from at least one of six surfaces of the pouch 120, on which the sealing portion 124 subjected to heat is formed. That is, in the case of the battery cell 100a shown in FIGS. 1 to 4, the protrusion 130a may protrude inwards from at least one of the first surface 128a of the pouch 120 on which the sealing portion 124 is formed and the second surface 128b adjacent to the first surface 128a. In other words, the protrusion may be formed on any surface of the case adjacent to a sealing portion.

Such a protrusion 130a may cause the space of the receiving portion 123 of the pouch 120 to be slightly reduced. Thereby, even though the electrode assembly 110, which is smaller in size than the receiving portion 123 and thereby is movable in the receiving portion 123, moves towards the sealing portion 124, the protrusion 130a inhibit the electrode assembly 110 from coming closer to the sealing portion 124. Further, even if heat is applied to the outer portion of the pouch 120 to form the sealing portion 124, the electrode assembly 110 may be less affected by heat because the approach of the electrode assembly 110 to the sealing portion 124 is inhibited, thus inhibiting the electrode assembly 110 from being fused. Further, even when the battery cell 100a has been manufactured and then is used, the protrusion 130a limits the movement of the electrode assembly 110, thus allowing the battery cell 100a to be more safely used even if shocks are exerted on the battery cell 100a.

As described above, the protrusion 130a may be provided on the first surface 128a of the pouch 20 through which the electrode tab 114 protrudes and the second surface 128b adjacent to the first surface 128a. Here, the protrusion 130a may be formed on the first surface 128a, the second surface 128b, or both of them, depending on the winding direction of the electrode assembly 110. To be more specific, when a winding axis of the electrode assembly 110 is identical to the direction in which the electrode tab 114 protrudes as shown in FIGS. 1 to 4, the separator 113 of the electrode assembly 110 may be exposed towards the first surface 128a of the pouch 120. In order to inhibit the separator 113 from being fused by heat, the protrusion 130a may be formed on the first surface 128a of the pouch 120. Thus, it is possible to limit the approach of the electrode assembly 110 to the first surface 128a of the pouch 120. Here, if the sealing portion 124 is also formed on a third surface 128c that is opposite to the first surface 128a, the protrusion 130a may be provided on the third surface 128c.

Further, if the winding direction of the electrode assembly 110 is different from the above-described direction, namely, the winding axis of the electrode assembly 110 is oriented towards the second surface 128b of the pouch 120, the separator 113 is exposed through the second surface 128b of the pouch 120. Thus, the protrusion 130a may be formed on the second surface 128b of the pouch 120.

As described above, the receiving portion 123 of the pouch 120 may be formed by the deep drawing process. In order to prevent the pouch 120 from being broken while the receiving portion 123 is formed, the receiving portion 123 may be formed to be inclined. That is, the receiving portion 123 may be implemented such that its sectional area is reduced as the receiving portion 123 is away from a position where the first case 121 meets the second case 122. Thus, at least one of the surfaces of the pouch 120, namely, the first surface 128a, the second surface 128b, and the third surface 128c may be inclined.

Here, the protrusion 130a provided on the surface of the pouch 120 on which the sealing portion 124 is formed may also be inclined along the surface. For example, an end 131a of the protrusion 130a may be inclined to be parallel to the first surface 128a of the pouch 120. Further, a plurality of protrusions 130a may be provided. In this regard, the protrusions 130a may be separated from or connected to each other. However, the protrusions 130a may comprise one protrusion 130a, protrusions 130a may protrude from a surface of the pouch 120 at predetermined intervals, or one protrusion 130a may protrude entirely from the surface of the pouch 120, without being limited to the above-described configuration. Further, the protrusion 130a may protrude from the surface of the pouch 120 to 0.3 to 0.5 mm. If the protruding length is 0.3 mm or less, the electrode assembly 110 becomes adjacent to the sealing portion 124, so that there is a limit to reduce the effect of heat. On the other hand, if the protruding length is more than 0.5 mm, stress concentrates on the protrusion 130a, so that the protrusion 130a may be broken.

The protrusion 130a may be made as follows: at least one surface of the pouch 120 is deformed to form a concave portion on an outer surface thereof and a convex portion on an inner surface thereof, as shown in FIG. 4. That is, the protrusion 130a is integrally formed on the pouch 120. Here, the protrusion 130a may be formed when the pouch 120 undergoes the deep drawing process or is deformed using an additional tool. However, without being limited thereto, according to another embodiment, it is possible to implement the protrusion 130a by connecting an additional member to at least one surface of the pouch 120.

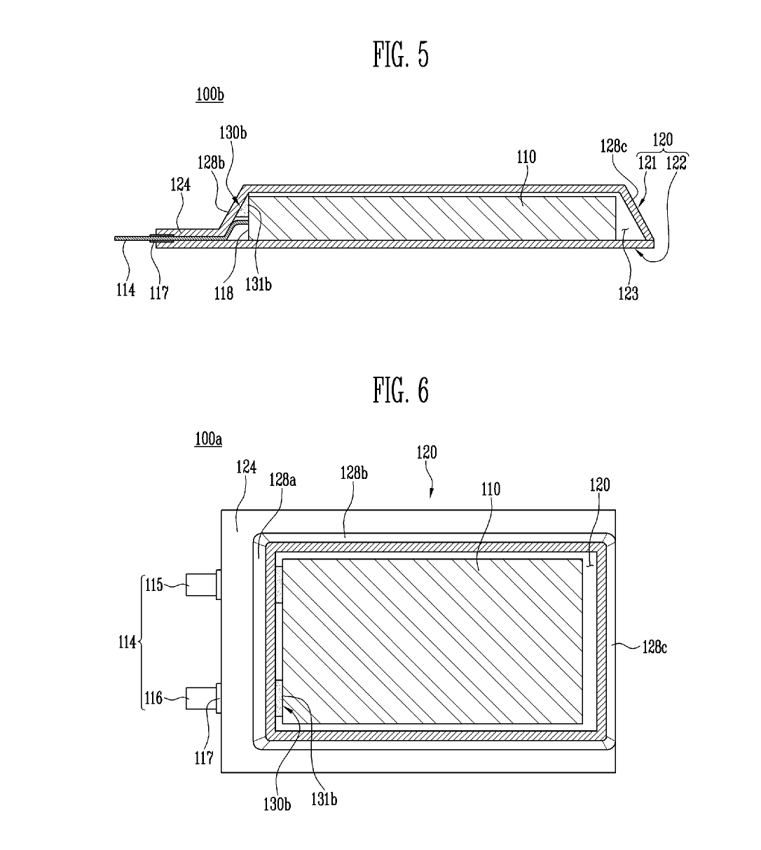

FIGS. 5 and 6 are sectional views showing a battery cell 100b according to another embodiment of the present invention. Hereinafter, the battery cell 100b according to this embodiment will be described with reference to FIGS. 5 and 6. Elements common to both the embodiments will carry the same reference numerals, and a duplicated description thereof will be omitted herein.

As shown in FIGS. 5 and 6, the battery cell 100b according to this embodiment includes an electrode assembly 110 and a pouch 120. An end 13 lb of the protrusion 130b provided on the pouch 120 may form an angle with a surface of the pouch 120. To be more specific, unlike the previous embodiment, at least one surface (e.g. the first surface 128a) of the pouch 120 on which the protrusion 130b is formed may not be parallel to the end 131b of the protrusion 130b, and an end 118 of the electrode assembly 110 may be parallel to an end 131b of the protrusion 130b. That is, when seen from the sectional view of FIG. 5, the protrusion 130b may have a triangular section, for example.

When the end 131b of the protrusion 130b is parallel to the end 118 of the electrode assembly 110, the protrusion 130b may be in surface contact with the electrode assembly 110, thus more effectively preventing the separator 113 of the electrode assembly 110 from approaching the sealing portion 124.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery cell, comprising:
an electrode assembly including an electrode tab; and
a pouch configured to accommodate the electrode assembly therein,
wherein a protrusion is provided on at least one surface of the pouch, the protrusion protruding towards the electrode assembly.

2. The battery cell of claim 1, wherein the pouch comprises a sealing portion formed along an outer portion thereof, and
the protrusion is provided on at least one surface of the pouch having the sealing portion.

3. The battery cell of claim 2, wherein the electrode tab protrudes out through the sealing portion.

4. The battery cell of claim 1, wherein the protrusion is provided on a first surface through which the electrode tab protrudes out of the pouch.

5. The battery cell of claim 4, wherein a separator of the electrode assembly is exposed towards the first surface.

6. The battery cell of claim 1, wherein the at least one surface of the pouch having the protrusion is inclined.

7. The battery cell of claim 6, wherein an end of the protrusion is inclined to be parallel to the at least one surface of the pouch having the protrusion.

8. The battery cell of claim 6, wherein an end of the protrusion forms an angle with the at least one surface of the pouch having the protrusion.

9. The battery cell of claim 8, wherein the end of the protrusion is parallel to an end of the electrode assembly.

10. The battery cell of claim 1, wherein the protrusion is provided on a second surface adjacent to the first surface through which the electrode tab protrudes out of the pouch.

11. The battery cell of claim 1, wherein the pouch comprises a first case configured to define a receiving portion receiving the electrode assembly therein, and a second case configured to cover the first case, and
a sectional area of the receiving portion is reduced in a direction away from a position where the first case meets the second case.

12. The battery cell of claim 1, wherein the protrusion protrudes from the at least one surface of the pouch to 0.3 to 0.5 mm.

13. The battery cell of claim 1, wherein the protrusion comprises a plurality of protrusions.

14. The battery cell of claim 1, wherein the protrusion is integrally formed on the pouch.

15. A battery cell comprising:
a housing that has interior walls that defines an interior space wherein the housing has a first and second member that are sealed together at at least a first surface;
an electrode assembly that is positioned within the interior space wherein the housing includes at least one protrusion formed on an interior wall adjacent the first surface so as to space the electrode assembly from the first surface.

16. The battery cell of claim 15, wherein the electrode assembly comprises electrode that extend out of the housing via the first surface.

17. The battery cell of claim 15, wherein the interior wall having the at least one protrusion is inclined.

18. The battery cell of claim 17, wherein the at least one protrusion is inclined so as to be parallel to the inclined interior wall of the housing.

19. The battery cell of claim 17, wherein an end of the protrusion forms an angle with at least interior wall of the housing.

20. The battery cell of claim 19, wherein the end of the at least one protrusion is parallel to an end of the electrode assembly.
